(19) United States
(12) Patent Application Publication
(10) Pub. No.: US 2014/0041184 A1
(43) Pub. Date: Feb. 13, 2014

(54) DEVICE AND METHOD FOR MACHINING OF AN OPTICAL LENS

(71) Applicants: Gunter Schneider, Marburg (DE); Torsten Gerrath, Marburg (DE)

(72) Inventors: Gunter Schneider, Marburg (DE); Torsten Gerrath, Marburg (DE)

(73) Assignee: Schneider GmbH & Co. KG, Fronhausen (DE)

(21) Appl. No.: 13/985,674

(22) PCT Filed: Feb. 10, 2012
(86) PCT No.: PCT/EP2012/000605

§ 371 Date: Oct. 23, 2013

(30) Foreign Application Priority Data
Feb. 15, 2011 (EP) 11 001 195.4

(51) Int. Cl. G01B 11/30

(52) U.S. Cl. CPC G01B 11/30
USPC 29/407.04; 29/705

(57) ABSTRACT

A device and a method for machining of a border of an optical lens in which the transition of the lens material to a blocking material or film material which adjoins along a border edge is optically detected in order to determine the shape of the border edge.

### BACKGROUND OF THE INVENTION

1. Field of the Invention

This invention relates to a device for machining of an optical lens, a method for machining of an optical lens, and use of a blocking piece or blocking material for the machining of an optical lens.

2. Description of Related Art

An optical lens, especially for eyeglasses, should have certain optical properties. The associated desired optical data of the lens are determined, for example, by an optician. In the past, lenses were used with predetermined optical data, for example, with diopters which could be obtained in different stages. However, increasingly lenses are being used which have the respectively desired individualized optical data and the accompanying optical properties. These lenses are then machined or fabricated depending on the respectively desired optical data, the lens being machined especially by cutting, preferably by turning and/or milling.

To machine a lens, according to this invention and as already known from the prior art, the lens is temporarily fastened (blocked) on a so-called blocking piece as a holder. During blocking, the lens is held especially by means of a blocking material. Especially preferably, the blocking material is liquefied for blocking and poured against a flat side of the lens. This flat side of the lens can be covered by a film attached to the lens especially when the flat side has already been machined to completion. In this case, the blocking piece or blocking material holds the blocked lens via the film.

The blocked lens can be machined on the peripheral side, therefore the border side, especially by cutting or profiling in order to match the lens to an eyeglass frame or desired border shape especially when used in eyeglasses as spectacle glass. This type of machining is also called border machining.

Within the scope of this invention the term “border” is defined especially as a peripheral-side surface which is preferably closed over the periphery. For example, in a lens with a round outer contour, the border therefore forms a cylindrical surface, but generally another shape is obtained.

The term “edge” within the scope of this invention is defined preferably as the especially essentially linear transition from the border to an adjacent face or flat side.

After first border machining or rough machining, the knowledge of the shape of the edge is necessary or at least advantageous especially for further machining and/or for quality control. This shape can be determined fundamentally with a corresponding measuring machine or the like. The use of this measuring machine is, however, very complex, and in particular, is not suited for manufacture of eyeglasses with high throughputs.

European Patent Application EP 1 250 979 A2 and corresponding U.S. Pat. No. 6,749,377 B2 describe a method for border machining of an optical lens. The border of the lens which can be turned angle-controlled around the turning axis of the workpiece is pre-machined by means of a border machining tool which can be fed axially, the lens acquiring the corresponding peripheral contour which corresponds to a lens mount except for a small excess dimension. Proximity measurement of the pre-machined lens border and machining of the lens border to completion take place with consideration of the determined border data. To enable more accurate and more prompt determination of the border data, a border surface which is dull specifically in the dry state is produced in the pre-machining. The dry or dried surface is measured without contact by means of a laser and a video camera.

German Utility Model DE 20 2010 011 335 U1 and corresponding to U.S. Patent Application Publication 2012/0208036 A1 disclose a blocking material for blocking of an optical lens on a blocking piece, and the blocking piece and/or blocking material together with the lens can be machined by cutting on the peripheral side, in order for example, to implement ellipsoidal shaping.

### SUMMARY OF THE INVENTION

The object of this invention is to devise a device and method for machining of an optical lens, the machining of one border and/or one border edge being enabled or facilitated and/or the determination of the shape of one edge being enabled or facilitated.

The aforementioned object is achieved by a device, a method and a use of a blocking piece or material as described.

One aspect of this invention is that the lens is blocked on a blocking piece and the blocked lens, especially together with the blocking piece, is machined on the peripheral side, therefore the border side. Prior to this (first) border machining, likewise especially profiling can be performed, preferably polishing, and/or coating, especially of the flat side of the lens facing away from the blocking piece. Thus simple and fast machining is enabled since, in particular, re-clamping or other fastening, especially blocking, of the lens is not necessary. Furthermore, individual machining is enabled since the blocking piece or blocking material is or can be removed at the same time as the border machining of the lens, as a result of which more or less any border shapes can be implemented without having to consider a certain diameter of the blocking piece or a certain axial position of the blocking piece relative to the lens during blocking and/or machining. Accordingly, simple and fast machining of the lens is enabled.

Another aspect of this invention is that—especially after the (first) border machining—the transition between the lens material and the adjoining blocking piece, blocking material or film material and/or the transition of the film to the adjoining blocking piece or blocking material is optically detected in order to determine therefrom the shape of the border edge of the lens facing the blocking piece or the blocking material. This allows or facilitates a very simple, exact and/or prompt determination of the shape of the border edge and accordingly simple, accurate and/or prompt machining, for example, subsequent further machining or precision machining of the border and/or of the border edge.

As suggested, for the blocking piece, the blocking material and/or the optional film a material or different materials is or are used which differs or differ with respect to color, reflectivity, transmissivity and/or luminescence from the material of the lens or film to facilitate optical detection of the indicated transitions or border shapes. This allows especially a very simple, reliable and/or prompt detection, as a result of which the machining of a border and/or a border edge is first enabled or at least facilitated and/or the determination of the shape of one edge is first enabled or facilitated.

Optical detection takes place especially by means of a camera. The camera is located especially laterally next to the lens and/or can be moved relative to the lens over the lens periphery. This allows very simple and/or economical implementation. In particular the optical detection takes place without re-clamping of the lens and/or of the blocking piece.

Especially preferably, the lens or the blocking piece can be rotated angle-controlled and/or the rotary position or angular position of the lens is acquired in the optical detection of the indicated transition or the indicated transitions. The shape of the border edge is determined especially preferably from the detected transition or from the detected transitions with consideration of the rotary or angular position during the optical detection. This enables especially assignment of the rotary position of the shape to the rotary position of the lens.

Preferably, in addition to the aforementioned optical detection, also distance measurement takes place, especially for determining the radius of the border and/or the border edge of the lens, therefore of the distance of the machined border from one axis around which the lens is turned during optical detection. This measurement is taken preferably optically or without contact, for example, by means of the camera and/or a second camera which is located, for example, obliquely or transversely to the first camera and/or by laser measurement or the like. However, the measurement can also take place by a feeler or in some other suitable manner.

The shape of the border edge is determined especially preferably by smoothing and/or approximation and/or using specified data or machining data and/or with consideration of the set thickness or average thickness of the film, if present, from the detected transition or the detected transitions. The defined shape is therefore especially an approximation. Thus, simple, accurate and/or prompt determination of the shape can take place. Accordingly, very fast machining is enabled.

Another aspect of this invention is that the border edge of the blocked lens which is machined on the peripheral side or border side is machined especially with the blocking material or blocking piece directly adjoining or located on the border edge to be machined, and between the lens on the one hand and blocking material or blocking piece on the other there can optionally be a film or other intermediate layer, adhesive layer or the like. This in turn allows simple and/or fast machining. In particular re-clamping or re-blocking of the lens is not necessary even for special border shapes.

Preferably, a blocking material and/or blocking piece of plastic is used for blocking of the lens. This facilitates its machining and allows especially defined profiling, especially preferably cutting of the blocking material and/or blocking piece together with the lens, in particular with the same machining tool. This is conducive to simple and fast machining.

Individual aspects and features of the aforementioned and following aspects and features of this invention can be optionally combined with one another, but also can be implemented independently of one another.

Other aspects, features, advantages and properties of this invention will become apparent from the following description of a preferred exemplary embodiment with reference to the accompanying drawings.

### BRIEF DESCRIPTION OF THE DRAWINGS

FIG. 1 shows a schematic structure of a proposed device with a lens to be machined,

FIG. 2 is a schematic view of the blocked lens with an assigned camera and illumination apparatus, and

FIG. 3 shows an extract enlargement from FIG. 2.

### DETAILED DESCRIPTION OF THE INVENTION

For the same or same type of components and apparatus, the figures use the same reference numbers, the same or corresponding advantages and properties arising even if a repeated description is omitted.

The subject matter of the invention is a device 1 for machining of an optical lens 2. The starting point for formation or machining of an optical lens 2 is a lens blank. It is machined by cutting or some other profiling and preferably in several machining steps such that at the end there is a finished optical lens 2 with the desired optical properties. The term “lens” within the scope of this invention designates preferably both the lens blank before carrying out the necessary machining steps, and also the finished lens 2 at the end.

The lens 2 or lens blank preferably is made of plastic. However, fundamentally, also some other material which can be suitably machined, optionally also glass or mineral glass, can be used. If the finished lens 2 is to be used for eyeglasses (not shown), which is preferably the case, the lens 2 of this invention is also called spectacle glass, even if the lens 2 may not necessarily be made of glass.

The device 1 preferably has at least one or solely one machining apparatus 3 for especially cutting or other profiling of the lens 2 as a workpiece to be machined.

In the illustrated preferred exemplary embodiment, the machining apparatus 3 preferably has a workpiece spindle 3A which can be moved preferably in an X direction and Y direction, especially by means of a compound slide which is only suggested. The two directions X and Y preferably run transversely or perpendicular to one another.

The workpiece spindle 3A is especially a preferably directly driven, precision-mounted shaft or a direct drive or other drive, each with preferably integrated or assigned interface or fixture 3B for the workpiece, here therefore, for the lens 2 or lens blank. Fundamentally, direct chucking or clamping of the lens 2 can take place. Preferably, the lens 2 is clamped or machined in the blocked state. Preferably, the lens 2 or lens blank is held indirectly via a holder or so-called block 4, especially a so-called blocking piece 4B. The blocking piece 4B is then clamped.

In the illustrated example, the workpiece spindle 3A preferably has a fixture 3B, especially a collet, for the blocking piece 4B.

The lens 2 and the blocking piece 4B can be preferably clamped in a certain axial position and/or rotary position in order to be able to machine the lens 2 in a defined manner. To do this, the blocking piece 4B can have a corresponding shape especially in a shaft region or clamping region.

The clamped lens 2 can be set into rotation for machining by means of the workpiece spindle 3A. The workpiece spindle 3A therefore forms especially a rotary drive for the lens 2. The workpiece spindle 3A forms especially a computed or controlled round axis C. In particular, CNC control of the workpiece spindle 3A or of the rotation of the lens 2 takes place.

The lens 2 with a defined rotational position can be set into rotation especially preferably controlled or regulated.

In the illustrated exemplary embodiment, the workpiece spindle 3A with the clamped or blocked lens blank 2 can be moved preferably in the X direction and/or Y direction and/or in the Z direction relative to a machining tool, for example, by means of a compound slide which can be moved in the X and Y direction with the workpiece spindle 3A and/or by means of a slide or linear drive which can be moved in the Z direction and which bears the drive 3C. In particular, a controlled X axis, Y axis and/or Z axis and linear axes are formed. The Z axis runs preferably transversely or crosswise to the X and/or Y direction and/or at least essentially parallel to the C axis.

Fundamentally, also other or additional directions and/or axes of movement are possible. In particular, the axial alignment of the rotational axis C of the workpiece spindle 3A can also run and/or can be pivoted obliquely to the Z direction, especially around the suggested pivoting axis B. The axis B runs preferably transversely or perpendicular to the C axis, Z axis and/or Y axis and/or parallel to the X axis.

The term “axis” in this invention is defined as a controlled or regulated or computed axis of movement, such as a linear axis or round axis, especially preferably within the scope of the terminology in CNC controls (numerical or computerized controls). This applies especially to individual parts or all parts of the machining apparatus 3 or to the device 1 in accordance with the invention.

The machining apparatus 3 is preferably made for machining of the lens 2 by milling, grinding and/or polishing. However, the machining apparatus 3 can also, alternatively or additionally, enable other machining, especially cutting or profiling of the lens 2.

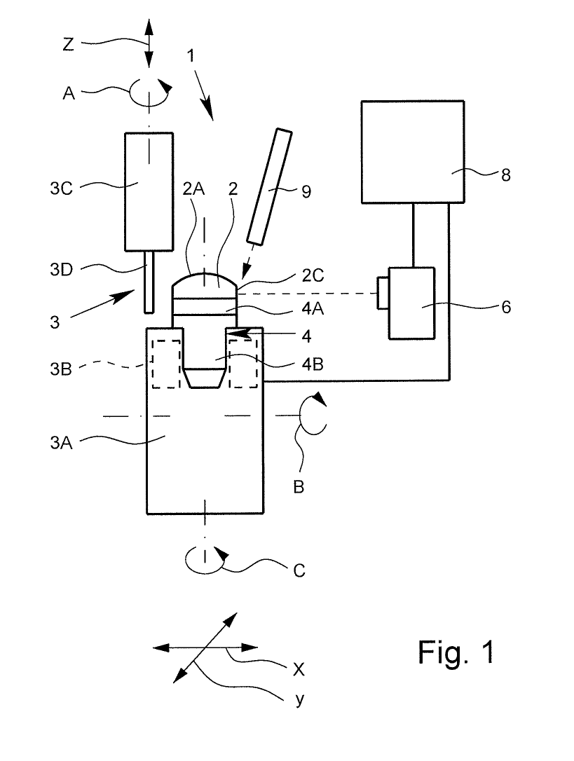

In the illustrated example, the machining apparatus 3 preferably has a holder or drive 3C with a tool 3D such as a milling cutter. Here, the machining tool is especially the milling tool 3D which can be set into rotation by means of the drive 3C, especially around the axis A of rotation which is schematically suggested in FIG. 1. The axis A runs preferably at least essentially parallel to the Z axis.

The lens 2 and the respective machining tool 3C can preferably be fed and/or moved relative to one another in order to enable the respective machining.

The machining apparatus 3 is preferably made for border machining of the lens 2. This will be explained in detail below.

In addition, the device 1 or machining apparatus 3 according to one version, optionally with another machining tool (not shown), can also be used for machining of a flat side 2A of the lens 2, especially the flat side 2A of the lens 2 facing away from the blocking piece 4B. In this case, the lens 2 or its flat side 2A is especially preferably machined by face turning and/or milling.

The other flat side 2B of the lens 2 facing the blocking piece 4B is connected directly or indirectly to the blocking piece 4B. Especially preferably, this flat side 2B facing the blocking piece 4B is already machined and/or is protected by an optional film 5 against damage, especially by the blocking piece 4B or by blocking material 4A of the blocking 4. The flat side 2B of the lens 2, for example, forms a front side of a spectacle glass or the lens 2 when used in eyeglasses (not shown) or in an eyeglass frame (not shown).

The film 5 is preferably made very thin. The thickness is preferably roughly 0.05 to 0.2 mm, especially roughly 0.1 mm or less. The film 5 preferably has a defined and/or essentially uniform thickness.

The film 5 is made especially of plastic. The film 5 is attached with a flat side 5A to the lens 2, for example, cemented onto the lens 2, in particular, at least essentially over the entire surface. The other flat side 5B faces the blocking piece 4B and is connected preferably at least essentially in a blanket manner to the blocking piece 4B or blocking material 4A. But, the film 5 and its flat side 5B can also be connected only in regions or spots to the blocking piece 4B or blocking material 4A.

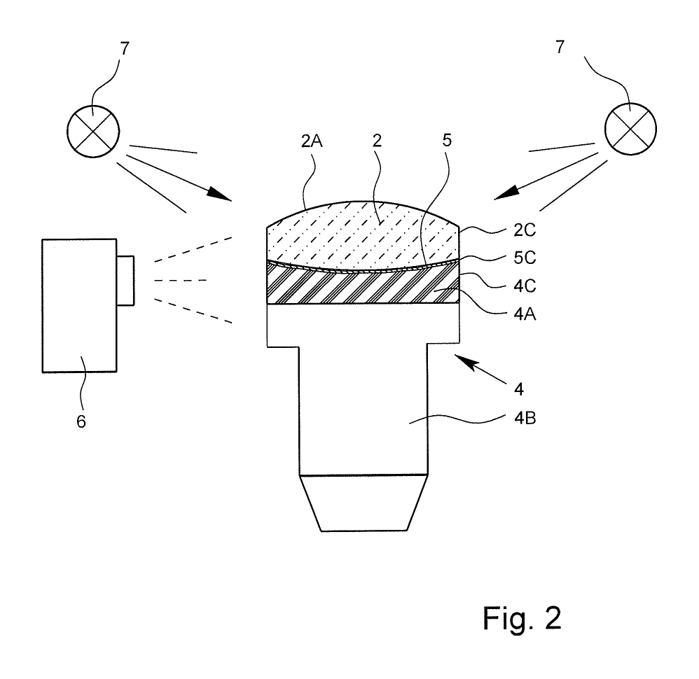

The blocking piece 4B bears preferably the blocking material 4A which is connected or is being connected to the lens 2 or the assigned film 5 for blocking of the lens 2. The blocking material 4A is especially a plastic, especially preferably as described in German Utility Model DE 20 2010 011 335 U1 and corresponding to U.S. Patent Application Publication 2012/0208036 A1 which are hereby incorporated by reference. However, the blocking material 4A can also be fundamentally an alloy which melts preferably at low temperature, such as a so-called alloy block material, a resin, a wax, an adhesive, an adhesive tape or the like. Especially preferably, the blocking material 4A connects the lens 2 and film 5 by corresponding adherence to the lens 2 or blocking material 4B, as suggested in FIGS. 2 & 3. However, other mechanical implementations are also possible.

In the figures, the lens 2 is connected to the blocking piece 4B. This state connected to the blocking piece 4B is also called “blocked”. The holding by the blocking material 4A and the blocking piece 4B is also called blocking 4.

In the illustrated example, the blocking piece 4B is preferably radially widened in a region 4E which adjoins the lens 2 and the blocking material 4A, relative to a clamping region. This is especially preferred with respect to a large support surface, adhesion surface and/or contact surface of the blocking piece 4B toward the lens 2 or film 5. The region 4E preferably forms an axial stop or axial rest for the blocking piece 4B when clamped in the fixture 3B.

The blocking material 4A adheres preferably at least essentially in a blanket manner to the lens 2 or film 5 (if present). Here, it is noted that the lens 2 initially can laterally project also radially or on the border side beyond the blocking piece 4B and/or blocking material 4A, but in the border machining preferably is removed to such an extent that preferably also the blocking piece 4B, especially in the region 4E, or the blocking material 4A is still removed (somewhat) on the peripheral side.

Fundamentally, the blocking piece 4B or blocking material 4A can however also adhere only partially to the lens 2 or film 5, for example, can bear or hold the lens 2 or film 5 only at several support sites which are separate from one another and/or in an annular area or the like.

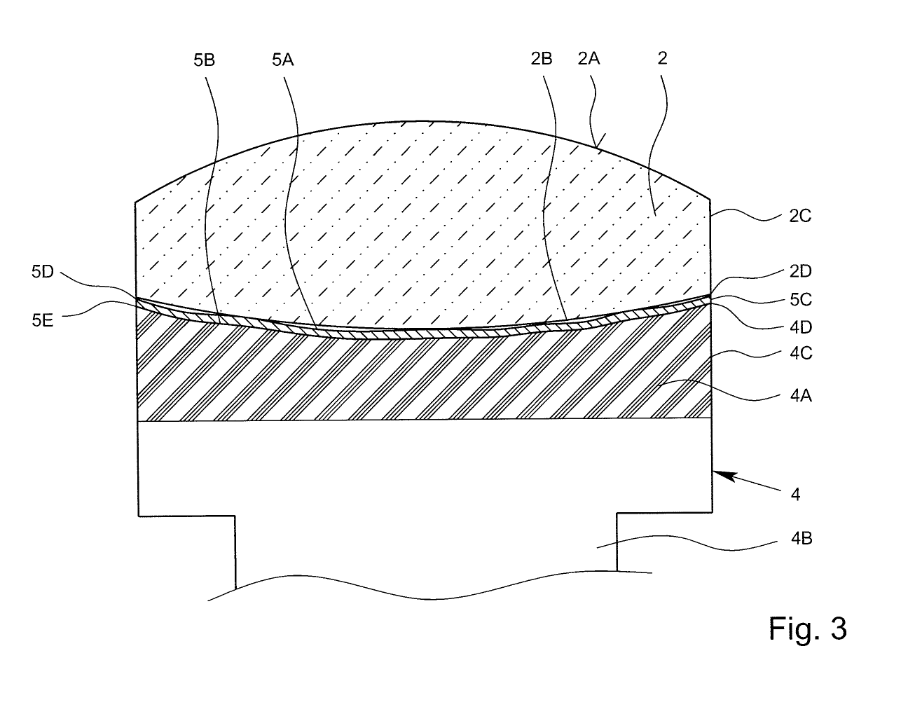

FIG. 2 schematically shows the blocked lens 2, therefore the lens 2 with assigned blocking piece 4B or blocking piece attached to it, and an assigned camera 6 and an illumination apparatus 7 of the device 1, two different arrangements of the illumination apparatus 7 being suggested. FIG. 3 is an extract enlargement of FIG. 2 in the region of the connection of the lens 2 to the blocking piece 4B or blocking material 4A.

The device 1 or machining apparatus 3 is preferably made such that the lens 2 is or can be profiled, especially cut on the peripheral side, therefore the border side. Especially preferably, the border 2C of the lens 2 can be machined, especially by milling and/or grinding or by means of the tool 3D. Thus, the lens 2 can acquire a desired border shape, for example, a round, oval or optionally also angular or other outer contour or border shape.

The border machining can take place in one step or in several steps. For example, first coarse machining or preliminary machining, and then, precision machining can take place. Furthermore, the border machining can also be combined with edge machining. For the different machining steps or machining also various tools 3D can be used and/or different types of machining, such as milling and grinding, can be combined.

The border is machined in the illustrated example with the lens 2 blocked. In particular, the blocking 4 composed of the lens 2 and blocking material 4A and/or blocking piece 4B is profiled on the peripheral side or border side. Preferably, in border machining of the lens 2 at least in part the blocking piece 4B and/or the blocking material 4A is machined or removed on the border side. This removal takes place especially on the peripheral side or border side, especially along one border 4C of the blocking material 4A and/or along the radially widened region 4E of the blocking piece 4B and/or around an annular region of the blocking piece 4B and/or blocking material 4A, which region preferably directly borders the lens 2.

Initially, the lens 2 can project radially to the outside over the blocking piece 4B or blocking material 4A. In border machining the lens 2 is then preferably removed radially such that at least in part also the blocking piece 4B and its blocking material 4A are partially removed on the border side or peripheral side, here machining or removal of the blocking piece 4B or blocking material 4A taking place especially preferably over the entire periphery, but it can also take place only in sections over the periphery. In the figures, the lens 2 and the blocking material 4A and blocking piece 4B are shown in the blocked state and after completed border machining.

In particular, the lens 2, on the one hand, and the blocking piece 4B and its region 4E and/or the blocking material 4A, on the other hand, at least in an axial region or partial region adjoining the lens 2, and its edges 2C and 4C form a more or less smooth outer border surface, especially together with the optional film 5 or its edge 5C which lies in between, such as suggested especially in the enlargement according to FIG. 3.

Especially preferably, the (machined) borders 2C, 4C and/or 5C of the lens 2, of the blocking material 4A, of the blocking piece 4B and/or of the film 5, in a longitudinal section along the longitudinal axis or axis C of rotation, run at least essentially parallel to the axis C. However, fundamentally, also an inclination of the border or of the borders 2C, 4C and/or 5C relative to this axis C is possible.

The edge (border edge) 2D of the lens 2, therefore the edge 2D of the transition from the border 2C to the flat side 2B, which edge faces the blocking material 4A and blocking piece 4B, is re-formed by the border-side machining of the lens 2. In particular, for quality control, for further machining of the lens 2 and of the border 2C and/or for machining of the border edge 2D, it is necessary or advantageous to determine the (new) shape of the border edge 2D.

Preferably, optical detection of the transition of the lens material to the blocking material 4A or blocking piece 4B or of the transition of the lens material to the film 5 or its border 5C or to the film material takes place when the film 5 is present and its border 5C can be detected, and/or optical detection of the transition of the film 5 or of the film material to the blocking piece 4B or blocking material 4A takes place, from this the shape of the border edge 2D being determined preferably with consideration of the rotary or angular position of the lens 2 and/or with consideration of the distance of the border 2C from the axis C or of the radius of the border 2C. For this optical detection, preferably, the device 1 has a corresponding detection apparatus, here especially the camera 6, and especially the assigned optional illumination apparatus 7 or the like.

Furthermore, the device 1 preferably has an evaluation apparatus 8 for the aforementioned determination of the shape of the border edge 2D from the optically detected transition or from the optically detected transitions or from corresponding data, especially video data, as is suggested schematically in FIG. 1.

The device 1 preferably has a cleaning apparatus 9 for removal, especially for blowing and/or rinsing machining residues or dirt, especially chips or the like, away from the blocking 4 or from the lens 2 prior to optical detection. By means of the cleaning apparatus 9 in particular, compressed air and/or cleaning liquid can be directed at the peripheral surface or the border 2C, 5C and/or 4C or in general at the lens 2 and/or the blocking 4. However, other designs are also possible. Alternatively or in addition, for example, a brush or other mechanical cleaning or the like can also be used.

One especially preferred method sequence, possible method versions and corresponding preferred embodiments of the device 1 are detailed below.

Optionally, the lens 2 is first profiled, especially cut on its flat side 2A facing away from the blocking 4 or blocking piece 4B. This machining can take place by the device 1 or machining apparatus 3 or at least in it. But, this machining can also take place separately. Depending on the configuration, re-clamping of the lens 2 or of the blocking piece 4B for the subsequent machining can take place or also may not be necessary, therefore avoided.

Preferably, the machined flat side 2A is coated afterwards or prior to border machining.

The lens 2 is then profiled, especially cut, on the peripheral side or border side, especially preferably to produce a certain border shape. The border machining takes place preferably with the lens 2 blocked. Preferably, in the border machining of the lens 2, the blocking piece 4B and/or its blocking material 4A is also machined or removed on the border side. The border machining can take place in several stages or steps and/or with different machining tools 3 or types of machining tools.

In particular, in border machining, first coarse machining takes place, especially the diameter both of the lens 2 and also of the blocking piece 4B or its region 4E and/or of the blocking material 4A being reduced, especially preferably the blocking material 4A is removed or cut at least partially to the same diameter as the lens 2 in order to form the starting contour for the final border machining. In the final machining, especially precision machining of the border 2C of the lens 2 takes place.

After border machining, preferably cleaning takes place, especially rinsing and/or blowing away machining residues, chips, or the like. The cleaning takes place especially by means of the cleaning apparatus 9 or compressed air, flushing liquid, or the like. The cleaning can also be repeated several times or can take place in several steps, especially for multistage border machining.

Then, the shape of the border edge 2D of the lens 2 facing the blocking piece 4B is determined. Beforehand, preferably border machining and cleaning are done. However, the cleaning is only optional. Furthermore, the border machining is also optional. The determination of the shape of the border edge 2D or some other border edge of the lens 2 which is explained below can therefore take place according to a version without prior border machining or other machining.

To determine the shape of the border edge 2D, first its (presumed) shape or the transition of the lens material to the blocking material 4A or blocking piece 4 or film 5 which preferably adjoins axially and/or directly is optically acquired, especially by means of the camera 6. Alternatively or in addition and/or simultaneously, the shape of the edge 4D of the blocking material 4A and/or of the border 5C of the film 5 and/or of edges 5D and/or 5E of the film 5 and/or of the transitions of the film material to the blocking piece 4B or blocking material 4A, which edge 4D faces the lens 2, is detected. In particular the detection takes place by recording a corresponding image, film or several images or by recording corresponding data or video data.

For optical detection over the entire periphery, preferably, the camera 6 is moved relative to the lens 2 around the periphery. This takes place especially preferably by corresponding turning of the lens 2, especially the respective rotary or angular position of the lens 2 in the optical detection or image acquisition being considered at the same time or also detected or stored and/or being assigned especially to the individual images. Here, the camera 6 can take several individual pictures in a tight sequence, for example, in different defined rotary positions or angle positions around the periphery of the lens 2 or from different sides of the lens 2, and/or also image data or a film can be continuously recorded. The data which have been recorded or acquired in this way (image data and/or film data) can be buffered and/or evaluated, especially in the evaluation apparatus 8, as necessary.

When using a matrix camera, preferably synchronization of angles (of the lens 2) and picture number takes place in development or optical detection.

In optical detection, therefore, preferably also the respective angle position of the lens 2 is considered or detected so that in the later evaluation and determination of the shape of the border edge 2D the angular position is correctly considered over the periphery of the lens border 2C.

The respective rotary or angular position of the lens 2 can be detected, for example, via the workpiece spindle 3A or an assigned sensor or the like and especially stored so that consideration in the evaluation, especially in the evaluation apparatus 8, is possible or becomes possible.

In particular, the aforementioned data and detected transition are evaluated in the device 1 or the evaluation apparatus 8. This evaluation which if necessary can take place alternatively or in addition also externally or separately from the device 1 is used especially for determination of the shape of the border edge 2D.

If necessary, the evaluation apparatus 8 can also be used to control the further machining of the lens 2, especially the (further) border machining and/or edge machining. Alternatively or in addition, the evaluation apparatus 8 or the device 1 can also store, display and/or output the data required for this purpose, such as the defined shape of the border edge 2D, for example, can make them available to another machining apparatus and/or can control them.

The determined shape can alternatively or in addition be used also for quality control and/or a termination measurement.

The shape of the border edge 2D is preferably determined to be accurate at least to 0.1 mm, especially to roughly 0.05 mm, or even more accurate.

It is noted that the lens 2 during the optical detection or recording can be moved continuously or discontinuously relative to the camera 6.

Furthermore, the lens 2 or the blocking 4 or the border 2C, 5C and/or 4C is preferably illuminated during optical detection, especially by means of the optional illumination apparatus 7. The illumination can take place for example, proceeding from the side of the camera 6 or on the camera side or adjacent to the camera 6, as suggested in FIG. 2 by the arrangement of the illumination apparatus 7 on the left side. Alternatively or in addition the illumination apparatus 7 or another illumination apparatus 7 can also be arranged opposite, especially on the side of the lens 2 opposite the camera 6 and/or transversely thereto or transversely to the recording direction laterally and/or above the lens 2. Alternatively or in addition, axial illumination of the lens 2, especially from overhead, as shown in FIG. 2, is also possible.

To facilitate the optical detection and/or evaluation, the optical detection preferably takes place under defined optical ambient conditions, for example, in a darkened room and/or with defined illumination, for example, only by the illumination apparatus 7.

Preferably, the illumination takes place with a defined or predetermined illumination spectrum, especially with at least essentially monochromatic light or laser light or the like.

The wavelength of the light with which illumination is provided or the illumination spectrum is preferably chosen such that the edges or transitions between the different materials, such as the lens material, the film material and/or the blocking material 4A, can be optically detected especially clearly or easily.

Preferably, materials with different optical properties are used. In particular, the lens material, the film material, and/or the blocking material 4A and/or the material of the blocking piece 4B differ with respect to their optical properties, especially with respect to color, reflectivity, transmissivity and/or luminescence. For example, the film material and/or blocking material 4A can be luminescent, the illumination apparatus 7 then preferably causing a corresponding luminescence which can be optically detected, especially by the camera 6. To do this, for example, illumination and/or detection are also done especially in the UV range.

To determine the shape of the border edge 2D, especially the different material structure and/or coloring of the lens material, on the one hand, and of the film material and/or blocking material 4A and/or material of the blocking piece 4B, on the other hand, can be detected and evaluated.

The camera 6 can be especially a line camera or matrix camera or some other corresponding image sensor, especially with suitable optics.

Preferably, the camera 6 is encapsulated and/or separated from the actual machining in some other way, for example, by a partition in order to avoid unwanted fouling or adverse effects on the camera 6 or the optical detection.

Preferably, the camera 6 and its optics or the like can be cleaned, for example, by the cleaning apparatus 9 or some other cleaning apparatus.

Alternatively or in addition, the camera 6 can be movable out of the actual machining space and/or the lens 2 to be examined or the blocking 4 to be examined, for example, can be movable by means of the indicated compound slide or workpiece spindle 3A, especially preferably without re-clamping, to the camera 6, especially preferably after completed border machining and/or cleaning, for example, into a corresponding examination space with the camera 6.

After the indicated optical detection, evaluation takes place. Here, an (approximated) shape of the border edge 2D is determined from the indicated data or information. Alternatively or in addition, here, the shapes of the border 5C and/or of the edges 5D, 5E and/or 4D are also determined.

To determine the shape of the border edge 2D, preferably, the following steps are executed or used individually or in any combination:

Smoothing and/or approximation of the shape of the border edge 2D takes place especially by a spline of higher order, for example, of fourth order or higher.

A correction of the curve of the border edge 2D takes place. For example, it can be considered here that the film 5 is often somewhat wavy over its outer periphery, and accordingly, does not adjoin the assigned lens 2, ideally, in a blanket manner over the outer periphery. With corresponding detection of the shape of the film 5 or of the border 5C and/or of the edge 5D and/or 5E of the film 5 it can be considered, for example, that the lens 2 rests only on elevations of the film 5 in the border area or elevations of the film form contact points on the lens 2 or the border edge 2D which is to be determined.

Specified data, for example, with respect to the expected specified curve of the border edge 2D and/or the set thickness of the film 5, are taken into account. In addition or alternatively, data can also be considered from the prefabrication or coarse machining.

An average thickness of the film 5 is determined from the acquired data or shapes; this thickness is used, for example, for correction of detected shapes or transitions, especially under the assumption of an at least essentially constant thickness of the film 5.

Thus, the shape of the border edge 2D can be determined, especially therefore approximated or approached, from the data and from the detected shapes or transitions.

The determined shape can then be stored, displayed and/or further processed. In particular, the determined shape is used for subsequent machining of the lens 2, of the border 2C and/or of the border edge 2D, for example, for beveling of the border edge 2D and/or some other machining, preferably profiling especially of the border edge 2D.

If necessary, in addition, a second camera can be used which preferably likewise observes the edge 2C, 5C, and/or 4C and/or is offset to the first camera 6 along the periphery, especially preferably by roughly 90° and/or is aligned transversely to the first camera 6, especially to be able to detect the radius or diameter of the machined border 2C, 5C and/or 4C and/or the border shape and radius shape or diameter shape depending on the rotary position and/or in order to enable a more accurate optical detection and evaluation.

Alternatively or in addition, the aforementioned detection of the radius or diameter can also be supported or implemented by a feeler and/or other distance or position measurement, for example, by an optical distance measurement or other distance measurement, for example, for measuring the distance from a fixed point or camera 6 to the border 2C, 5C and/or 4C.

The developed border 2C, 5C, and/or 4C which is optically detected by the camera 6 transversely to the development direction shows at least two zones or regions, specifically the border 2C of the lens material or of the lens 2 and the border 4C of the blocking piece 4B or blocking material 4A, which border lies underneath in the drawings, the border 5C still being located in addition as an intermediate region between these two regions or borders 2C, 4C upon insertion of the optional film 5. Preferably, the transitions between these regions are detected and/or evaluated.

Preferably, it is considered that during cutting or other border profiling chipping can arise on the border edge 2D and can lead to interruptions of the otherwise continuously running border edge 2D, and thus, also to faulty measurements. This chipping or faulty measurements can be corrected or filtered out especially by the already mentioned smoothing or approximation.

The film 5, if present, preferably has a known and/or constant film thickness. In the development, accordingly a uniform band must form. The band especially at the aforementioned chipping sites can form a continuously running edge 5D which is suitable especially for determining the actual shape of the border edge 2D in the region of the chipping of the lens material.

In this connection it should be considered that the shape of the border edge 2D in this invention is in general preferably an approximation which constitutes the actual shape after border machining, especially after coarse machining such that subsequently very accurate border machining or edge machining, especially precision machining, is possible with the desired precision or with low tolerances.

Since, when the film 5 is applied to the lens 2 just in the border region, folds and/or inclusion of air bubbles can occur, corresponding waves or distortions can occur, as schematically suggested in FIG. 3 in the slightly wavy shape of the border 5C relative to the border 2C. These distortions or waves are especially preferably filtered out. The corresponding can also occur in the transition of the film 5 to the blocking material 4A, and this, in turn, can be taken into account by corresponding filtering.

To determine the shape of the border edge 2D, in an arrangement without the film 5, the transition between the lens material, on the one hand, and the blocking material 4A, on the other hand, is detected and evaluated, in addition filtering of the material distortions, measurement errors, etc. can take place, especially in order to achieve a certain smoothing or a continuous shape.

When the film 5 is present, to determine the actual shape of the border edge 2D, the lens material-film material transition and/or the film material-blocking material 4A transition can be evaluated. These transitions constitute shapes. These transitions or shapes as required can be filtered in turn, as already mentioned above, especially for correction of material chipping, measuring errors or the like. In addition, especially in the evaluation of the transition or shape of the film material-blocking material 4A the film thickness can be considered, the film thickness in particular being assumed to be constant. The film thickness can be stipulated as a set point and/or can be determined by optical detection and subsequent evaluation, for example, as an average, and then can be used for correction.

The suggested determination of the shape of the border edge 2D, especially the evaluation, the smoothing and/or the approximation and/or other correction and/or data processing, especially of the data supplied by the camera 6 or the like, such as image data or film data, takes place or take place preferably by a corresponding processor or computer and/or by corresponding software and/or in the evaluation apparatus 8.

Furthermore, in addition or alternatively, an evaluation for material faults, cracks, unwanted chipping or the like can also take place. To do this, especially the data recorded by the camera 6 are evaluated accordingly.

Alternatively or in addition, one problematic determination of the actual shape of the border edge 2D or one which is not possible can indicate a fault. In this case, for example, additional checking or measurement can take place.

After determination of the shape, preferably further machining takes place, especially precision machining, of the lens 2, especially of the border 2C and/or the border edge 2D, with consideration of the determined shape. This further machining takes place preferably without re-clamping of the lens 2 or of the blocking piece 4B and/or in the same device 1 or machining apparatus 3 even if, optionally, other machining tools are used and/or also if another type of machining, for example, precision turning instead of milling, takes place.

1-15. (canceled)

16. A device for machining of an optical lens, comprising:
a lens made of a lens material,
at least one of a blocking piece and a blocking material on which the lens has been blocked,
a machining apparatus for peripheral-side machining of the lens which has been blocked, and
a camera for optical detection of at least one transition of the lens material to at least one of the blocking piece or blocking material, a film which is located between the lens and the blocking piece and a transition of the film to the blocking piece or blocking material, and
an evaluation device for determining a shape of the border edge of the lens facing the blocking piece or the blocking material from the at least one transition detected,
wherein, to facilitate optical detection, the material of the film or blocking material differs from that of the lens with respect to at least one of color, reflectivity, transmissivity and/or luminescence.

17. The device as claimed in claim 16, wherein further comprising a tool for machining the border edge of the lens on the peripheral side facing the blocking piece with the lens blocked.

18. The device as claimed in claim 17, wherein the tool for machining is adapted to machine the peripheral side facing the blocking piece depending on the shape determined by said evaluation device.

19. The device as claimed in claim 16, wherein the camera is located laterally near the blocked lens.

20. The device as claimed in claim 16, wherein the camera is movable relative to the lens around the periphery of the lens for detecting said at least one transition.

21. The device as claimed in claim 16, further comprising an illumination apparatus positioned for at least one of lateral and axial illumination of the lens during said shape detection.

22. The device as claimed in claim 21, wherein the illumination apparatus is located on in proximity to the camera.

23. The device as claimed in claim 21, wherein the illumination apparatus is located on a side of the lens opposite that at which the camera is located.

24. A method for machining a peripheral side of an optical lens that is blocked on a blocking piece or blocking material, comprising the steps of:
optically detecting of at least one transition of the lens material to at least one of the blocking piece or blocking material, a film which is located between the lens and the blocking piece and a transition of the film to the blocking piece or blocking material and
determining an actual shape of a border edge of the lens facing the blocking piece or blocking material,
machining a peripheral side of the blocking piece or blocking material together with the lens,
wherein, to facilitate optical detection, a material of the film or blocking material is selected which differs from that of the lens with respect to at least one of color, reflectivity, transmissivity and luminescence.

25. The method as claimed in claim 24, comprising the further step of removing machining residues prior to optical detection.

26. The method as claimed in claim 24, wherein the determining step is performed by at least one of smoothing, approximation, using specified data from the detected at least one transition.

27. The method as claimed in claim 24, wherein said machining is performed as a precision machining based on the determined shape.

28. The method as claimed in claim 24, wherein at least the peripheral side of the blocking piece or blocking material is made of plastic.
